(19) United States
(12) Patent Application Publication
(10) Pub. No.: US 2010/0241889 A1
(43) Pub. Date: Sep. 23, 2010

(54) POWER MANAGEMENT SYSTEM AND METHOD

(76) Inventors: Mark Y. Fu, Cupertino, CA (US); Ronald Kunin, Ronkonkoma, NY (US); John F. Sisto, Lynbrook, NY (US); Larisa Troyegubova, Nesconset, NY (US); Charles Forni, Setauket, NY (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/696,168

(22) Filed: Jan. 29, 2010

Related U.S. Application Data
(60) Provisional application No. 61/161,329, filed on Mar. 18, 2009.

(51) Int. Cl. G06F 1/32; G06F 3/00; G06F 13/00

(52) U.S. Cl. 713/324; 710/16; 710/300; 713/320

(57) ABSTRACT

In one embodiment, provided is a method that includes detecting disconnect of a link at a Universal Serial Bus (USB) device coupled to a USB host via a USB bus, disconnecting the USB device from the USB bus, and modifying a power state of the USB device to a reduced power state. Disconnecting the USB device from the USB bus includes configuring the USB device such that the USB host recognizes the USB device as being disconnected from the USB bus. The reduced power state allows the USB device to monitor a status of the link such that the USB device is able to detect a reconnect of the link.

### PRIORITY CLAIM

This application claims benefit of priority to U.S. Provisional Patent Application Ser. No. 61/161,329, entitled “Power Management System and Method”, filed Mar. 18, 2009, by Mark Y. Fu, Ronald Kunin, John F. Sisto, Larisa Troyegubova, and Charles Formi, which is hereby incorporated by reference in its entirety as though fully and completely set forth herein.

### BACKGROUND OF THE INVENTION

1. Field of the Invention

This invention relates to electronic circuits, and more particularly, to efficient power management of peripheral port connections.

2. Description of the Relevant Art

Computer systems typically include one or more buses that facilitate the exchange of data between various components of the system. For instance, computer systems typically include a Peripheral Component Interconnect (PCI) bus or a Universal Serial Bus (USB). USB is a standard serial bus interface for connecting devices, such as computer peripherals or portable music and video players, to a host computer for easy transfer of data. The USB Implementers Forum (USB-IF), an industry trade association incorporating companies from the computer and electronics industries, standardizes the design of USB.

USB allows several devices to be used without requiring manufacturer-specific device drivers to be installed on the host computer. USB allows devices to be connected and disconnected without a need to reboot the computer or to turn off the device. This type of connection may be referred to as hot swapping or hot plugging. Typically, when a USB device is connected to the USB, the USB device is recognized and communication is allowed without much or any user interaction. For example, the USB device may be recognized and installed virtually transparent to the user.

During use, USB devices may be controlled via device drivers located on the computer system. The drivers are typically loaded when the USB device is installed or connected and unloaded when the USB device is uninstalled or disconnected. These drivers generally control operations of the USB devices such as controlling operational power states of the USB device. Operational power states may include setting a level or amount of power consumed by the USB device.

In computer systems, power conservation is often a significant concern. For instance, in laptops or similar portable computer systems, various power conservation techniques and schemes may be implemented to increase battery life and reduce dependence on external power sources. Typically, power schemes may include reducing or virtually eliminating power supplied to certain components of the computer system. Generally, power schemes include reducing power to components that are not being used or that are capable of operating with a reduced amount of power. For example, in certain power schemes, the entire system, devices and/or processors can be set to different states that consume various levels of power. Power schemes may conform or be similar to the Advanced Configuration Power Interface (ACPI) or Operating System-directed configuration and Power Management (OSPM). In accordance with ACPI, system states may include G0, G1, G2, and G3 states, devices may include D0, D1, D2 and D3 states, and processors may include C0, C1, C2, or C3 states. Each of the states may include a progression of reduced power consumption that provides varying levels of performance. For example, in the case of processors, C0 includes an operating state that generally consumes the most power, C1 includes a halt state where the processor consumes less power and is not executing instructions but can return to execution virtually instantaneously, C2 includes a stop-clock state where the processor generally uses even less power and maintains software in a visible state that takes longer to wake up, and C3 includes a sleep state, deep sleep state, or deeper sleep state that generally uses little to no power but may take longer to reactivate or wake-up the processor.

Although power schemes and power management techniques can improve power conservation, there are certain components and interfaces that may not benefit from existing power schemes. For example, in general a USB device attached to the computer system prevents the processor unit of the computer system from entering a C3 state. This is because the USB Host Controller periodically fetches USB commands from cached memory and bus master reads from cached memory are typically snooped on the processor unit's cache. As a result, the processor unit will not enter the C3 state while the USB device is attached.

Although current Microsoft Windows Operating Systems (e.g., Microsoft Windows XP and Microsoft Windows Vista) support setting network devices, including USB networking devices, into a low power state when the entire computer system is entering a low power state, they do not allow certain drivers to put certain devices into a low power state at will when the computer system is fully powered or generally operational. These operating systems may not allow network device drivers to place a network device into a low power state while the system is in an operational state. For instance, if a network cable (e.g., an Ethernet link) is disconnected from a “USB to Ethernet” device, a traditional network device driver cannot place the USB to Ethernet device into a USB suspend mode. In turn, the USB host controller (USBHC) and its device driver continue to perform significant and frequent PCI bus mastering that creates accesses to memory, thereby not allowing the process to enter a sleep or deep sleep state. In other words, even with the network cable disconnected, the system continues to access the network device, preventing the processor from entering a sleep mode. Power is thus used to support an Ethernet device that is not even in use. As a result, more power is consumed, potentially leading to increased battery power drain and decreased battery life.

Certain proposals have been made to provide the ability to place such devices into a reduced power state. The proposals generally include making architectural changes to software drivers that could enable a networking device driver to place the network device into a reduced power state while the system is running. Unfortunately, the proposed techniques are currently unproven, may require a significant amount of time and investment in software development, and may even have compatibility issues with certain operating systems.

Accordingly, there is a desire to provide a viable and economical technique for controlling power states of USB devices. Further, there is a desire to provide a viable and economical technique for controlling power states of USB to Ethernet devices when an Ethernet link is removed or otherwise unavailable.

### SUMMARY OF THE INVENTION

Systems and methods for efficient power management of a computer system are contemplated and described. The computer system may comprise a USB interface which provides a USB bus, as well as a USB to Ethernet device (USB device). In one embodiment, provided is a method that includes detecting disconnect of a link at a universal serial bus (USB) device coupled to a USB host via a USB bus, disconnecting the USB device from the USB bus, and modifying a power state of the USB device to a reduced power state. Disconnecting the USB device from the USB bus includes configuring the USB device such that the USB host recognizes the USB device as being disconnected from the USB bus. The reduced power state allows the USB device to monitor a status of the link such that the USB device is able to detect a reconnect of the link.

In another embodiment, provided is a universal serial bus (USB) device that includes a first port for coupling to a USB bus, a second port for coupling to a link, and a USB device controller. The USB device controller is able to monitor the status of the link to determine if the link is connected or disconnected, and, if it is determined that the link is disconnected, the USB device controller is able to disconnect the USB device from the USB bus and modify a power state of the USB device to a reduced power state. Disconnecting the USB device from the USB bus includes configuring the USB device such that a USB host recognizes the USB device as being disconnected from the USB bus. The reduced power state allows the USB device to monitor a status of the link such that the USB device is able to detect a connection of the link.

In yet another embodiment, provided is a method that includes monitoring a status of an Ethernet Link to a universal serial bus (USB) device to determine if the Ethernet Link is active or inactive, and providing the USB device in a reduced power state if it is determined that the Ethernet Link is inactive. Providing the USB device in a reduced power state includes suspending operations on, or disconnecting a connection of, one or more data lines between the USB device and a USB bus coupled to a USB host controller such that the USB host recognizes the USB device as being disconnected from the USB bus, and includes providing a connection of the USB device to a power line of the USB bus such that the USB device is provided sufficient power to enable the USB device to monitor the status of the Ethernet Link in the reduced power state.

### BRIEF DESCRIPTION OF THE DRAWINGS

Advantages of the present invention will become apparent to those skilled in the art with the benefit of the following detailed description and upon reference to the accompanying drawings in which:

FIGS. 1A and 1B are generalized diagrams that illustrate a computing system utilizing a USB device in accordance with one or more embodiments of the present technique.

FIG. 2 is a schematic block diagram that illustrates a computing system utilizing a USB device in accordance with one or more embodiments of the present technique.

FIG. 3 is flowchart that illustrates a method of power management in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, well-known circuits, structures, and techniques have not been shown in detail to avoid obscuring the present invention.

As discussed in more detail below, certain embodiments include a technique for placing a USB device and associated host controller and processor devices into a reduced power state. In some embodiments, the USB device includes a network device (e.g., USB to Ethernet device) that is capable of being placed in a reduced power state (e.g., a sleep state) when an Ethernet link is removed (e.g., when a network cable is disconnected). In certain embodiments, when the Ethernet link is removed, the USB device is disconnected from the USB bus via an internal feature of a controller of the USB device or an external circuit, such as a USB switching of input/output (I/O) lines. In certain embodiments, the USB device is placed into a reduced power state such that it saves power while being able to monitor the status of the Ethernet link. In some embodiments, when the USB device is disconnected from the USB bus, the disconnect is recognized by a host controller of the USB bus, causing the device drivers for the USB device to be unloaded such that no further activity remains on the port, and the host controller is placed in a reduced power operating state (e.g., a deep sleep state). In certain embodiments, the USB device is capable of detecting when the Ethernet link is reestablished, and thereafter, exiting the reduced power state, enabling the host to recognize the network device has been reconnected and to reload the device drivers for use. The following discussion provides a detail description relating to USB networking devices, however, it will be appreciated that such a technique may be employed in a similar manner for other types of USB devices and/or devices used on other types of buses or employing other types of communication protocols.

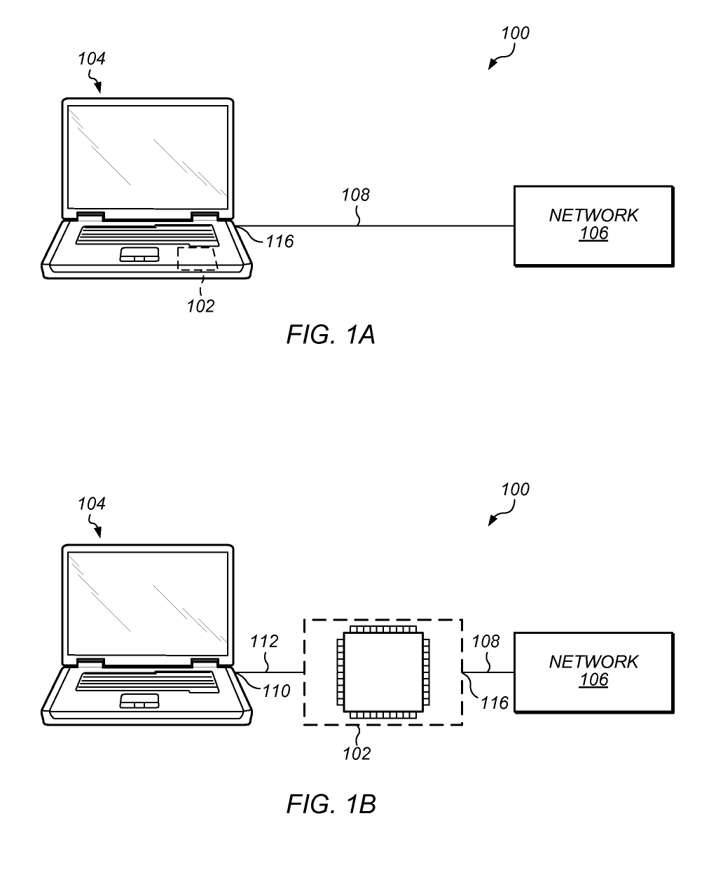

Turing now to the figures, FIGS. 1A and 1B depict a computing system 100 utilizing a USB device 102 in accordance with one or more embodiments of the present technique. In the illustrated embodiment, computer system 100 includes a computer 104 and a network 106. Network may include a local area network, the internet, or a similar data source or connectivity point. Computer 104 is connected to network 106 via a cable 108. In the illustrated embodiment, computer 104 includes a portable computer, such as a laptop computer. Other embodiments may include a desktop personal computer, an industrial computer, or similar computing devices.

In one embodiment, USB device 102 may be provided internal to an enclosure of computer 104. For example, in the embodiment illustrated in FIG. 1A, USB device 102 is an integral component of computer 104. In one embodiment, USB device 102 may be provided as an external component of computer 104. For example, USB device 102 may include a peripheral device, such as a dongle or another device that is coupled to computer 104. FIG. 1B illustrates an embodiment of USB device 102 that includes a peripheral device coupled to a port 110 of computer system 104 directly, or via cabling 112, as depicted. Such an embodiment may include a dongle, such as a USB to Ethernet dongle that can be plugged into port 110 (e.g., an external USB port) of computer 104.

In one embodiment, USB device 102 includes an adapter for communicating with network 106 via a USB bus of computer 104. For example, USB device 102 may include a USB to Ethernet device for connecting computer 104 to network 106. Such a USB to Ethernet device may enable computer 104 to connect to network 106 via cable 108 (e.g., an Ethernet cable) plugged into a port 116 of USB device 102 and a complementary port that connects to network 106.

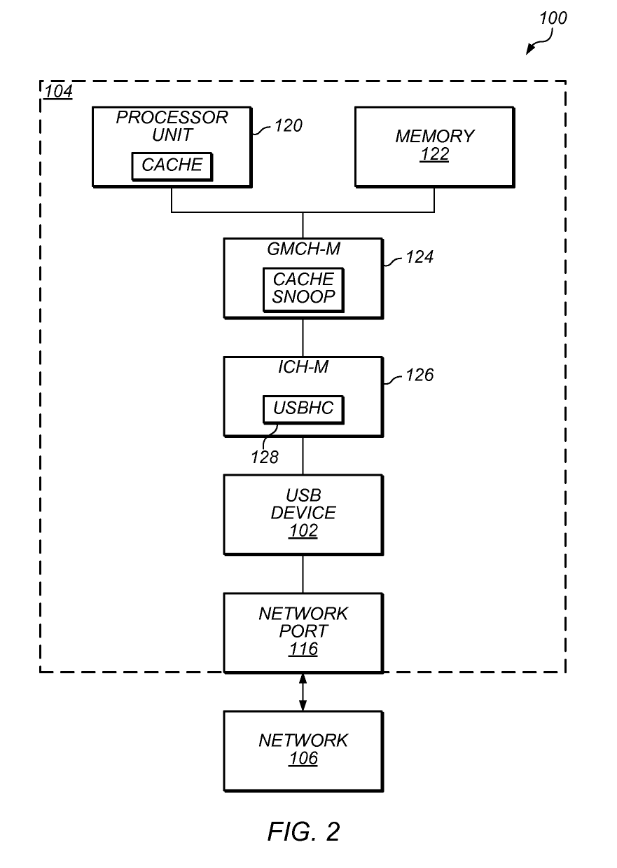

FIG. 2 illustrates a schematic block diagram of computer system 100 in accordance with one or more embodiments of the present technique. In the illustrated embodiment, computer 104 includes a processing unit (e.g., a central processor unit) 120, memory 122, a Graphics and Memory Control Hub (GMCH-M) 124, an I/O Controller Hub (ICH-M) 126, USB device 102, and network port 116.

Processor unit 120 may include one or more processor cores, wherein each processor core includes circuitry for executing instructions according to a predefined instruction set. For example, the x86 instruction set architecture (ISA) may be selected. Alternatively, the Alpha, PowerPC, or any other instruction set architecture may be selected. Each processor core may be implemented to simultaneously execute multiple software threads of a software application. In one embodiment, processor unit 120 includes one or more application specific integrated circuits (ASICs). Processor unit 120 may include one or more digital signal processors (DSPs), graphic processing units (GPUs), analog-to-digital converters (ADCs), and digital-to-analog converters (DACs). Other data processing semiconductor chip designs included within processor unit 120 are possible and contemplated. Further, these data processing designs may be physically implemented outside of processor unit 120 for interfacing, on-die routing and signal integrity, or other reasons.

In one embodiment, processor unit 120 includes one or more processors capable of accessing and executing routines stored on a memory 122. The routines may be executable to implement one or more methods, including methods for implementing power schemes of computer system 100. Although not shown, it is possible an ASIC, or other data processing die, may receive a command directly from an outside source. In one embodiment, a cache memory subsystem implemented as a L1 cache structure configured to store blocks of data, and possibly with an additional L2 cache structure, is integrated within processor unit 120. For example, in the illustrated embodiment, processor unit 120 includes a cache memory.

Memory 122 may include any form of memory medium capable of storing and sharing data. In one embodiment, memory 122 includes system memory, such as read-only memory (ROM), random-access memory (RAM), flash memory, a hard disk drive, a CD-ROM, a floppy disk or any suitable storage medium. Memory 122 may include routines stored thereon that are executable by processor unit 120 to implement one or more method useful for the operation of computer system 100. In some embodiments, memory 122 may be implemented as a L2 or L3 cache structure and may be directly coupled to processor unit 120. If a requested block is not found in an integrated cache structure or memory 122, then a read request may be generated and transmitted to a memory controller (not shown) in order to access outside memory to which the missing block is mapped. Outside memory, memory 122, and any integrated memory within processor unit 120 may comprise any suitable memory devices in addition to a cache structure. For example, these memories may comprise one or more RAMBUS dynamic random access memories (DRAMs), synchronous DRAMs (SDRAMs), DRAM, static RAM, sequential storage elements such as flip-flops and latches, etc.

In the illustrated embodiment, graphics and memory controller hub (GMCH) 124 is coupled between processor unit 120 and ICH 126, and between memory 122 and ICH 126. In one embodiment, GMCH 124 includes a cache snoop. GMCH 124 may be employed to monitor the bus, checking for broadcast on the bus that may invalidate a portion of the cache. For example, as the USB host controller fetches commands from cached memory, the bus master reads from cached memory may be snooped on the cache of processor unit 120.

In the illustrated embodiment, computer system 100 includes I/O controller hub (ICH) 126 coupled to GMCH 126. ICH 126 may be used to connect and control peripheral devices. In one embodiment, ICH 126 includes a USB host controller (USB HC) 128. USBHC 128 may provide one or more USB ports. Up to 127 devices, including the hub devices may be connected to a single USB host controller. USB devices are linked in series through hubs. There typically exists one hub known as the root hub, which is built into the USB host controller. The host controller directs traffic flow to devices, so no USB device can transfer any data on the bus without an explicit request from the host controller. In USB 2.0, host controller polls the bus for traffic, usually in a round-robin fashion. In SuperSpeed USB, connected devices can request service from host. When a USB device is first connected to a USB host, the USB device enumeration/initialization process is started. The enumeration starts by sending a reset signal to the USB device. The speed of the USB device is determined during the reset signaling. After reset, the USB device's information is read by the host, and the USB device is assigned a unique 7-bit address. If the USB device is supported by the host, the device drivers needed for communicating with the USB device are loaded and the device is set to a configured state. If the USB host is restarted, the enumeration process is repeated for all connected devices.

USB devices can be linked in series through hubs. A USB hub is a device that allows many USB devices to be connected to a single USB port on the host computer or another hub. USB hubs may be built into equipment, such as keyboards or monitors. Each hub has one upstream port and a number of downstream ports. The upstream port connects the hub (directly or through other hubs) to the host. Other hubs or USB devices may be attached to the downstream ports.

There are two types of hubs. First, a bus-powered hub is a hub that draws all its power from the host computer's USB interface. It does not need a separate power connection. A bus-powered hub is able to provide power to low-consumption USB devices without the need for an external power supply. A second type, a self-powered hub, is a hub that draws its power from an external power supply unit. Therefore, a self-powered hub is able to provide full power to every port.

There can only be one host per bus. The USB 2.0 Specification does not support any form of multi-master arrangement. The USB host is responsible for undertaking all transactions and scheduling bandwidth. Data may be sent by various transaction methods using a token-based protocol. Typically, USB host controller is built into modern computers, while older computers can be updated with the addition of hardware. For example, a hi-speed USB host controller may reside on a card that installs into any available slot on the motherboard and that provides one or more USB ports.

Both the USB host ports and the downstream USB hub ports implement port power management. Port power management is defined in the USB 2.0 Specification, which is supported by the USB-IF, to include a power switch and over-current protection with reporting. An external Port Power Controller, available from multiple manufacturers, provides single or dual USB port support when used with a USB hub.

The USB interface includes a master/slave architecture. The master is referred to as the “upstream” device or host/hub and the slave as the “downstream” device. The interface typically consists of four shielded wires: data positive (D+), data negative (D−), Bus voltage (VBUS), and Ground (GND). The two data lines, D+ and D−, are used for bi-directional data transfer and use differential drive techniques. The two power wires, VBUS and GND, are used to distribute power from the upstream host to the downstream device.

In the illustrated embodiment, USB device 102 includes a device connected to a port of USBHC 128 of ICH 126. In one embodiment, USB device 102 includes a High Speed USB to Ethernet controller, such as model LAN9500/LAN9500i Hi-Speed USB 2.0 to 10/100 Ethernet Controller manufactured by SMSC, headquartered in Hauppauge, N.Y. Such a device/controller may enable computer system 100 to connect to network 106 via USB bus and an Ethernet connection from the USB bus to network 106. For example, an Ethernet cable may be plugged into network port 116 and used to connect to a complementary port of network 106, as described above with respect to FIG. 1A. It is noted that although the illustrated embodiment of FIG. 2 includes USB device 102 and network port 116 as integral/internal to computer 104, other embodiments may include various configurations, such as USB device 102 including a peripheral device coupled to a port of computer system 104 directly, or via cabling, as depicted in FIG. 1B.

In certain embodiments, a technique may be employed to set a USB device into a reduced power state while the USB device still connected to a USB port of the USB bus/hub. In one embodiment, when the USB device is not being used for a certain function and/or is not provided a particular input, the USB device disconnects itself from the USB bus. The USB device may itself enter a reduced power state such that it can monitor various inputs to assess and determine whether or not is should reactivate itself to shift or return to another power state. When detached from the USB bus, the host system detects that the USB device is disconnected and suspend activity on the port such that certain components of the USB bus, such as the USB host controller and USB processors, can enter a reduced power state. The USB host controller may unload the device drivers for the USB device upon detecting that the USB device is no longer connected to the USB bus. In one embodiment, when the USB device is to be used for a certain function or is provided a particular input, the USB device may determine that it needs to reactivate itself, thereafter shifting or returning to another power state and reconnecting itself to the USB bus. The reconnection allows the USB host controller to recognize the presence of the USB device, thereby causing the components of the USB bus, such as the USB host controller and USB processors, to exit the reduced power state. The USB host controller may reload the device driver for the USB device upon detecting that the USB device is connected to the USB bus.

In one embodiment, the USB device includes a USB to Ethernet device that disconnects from the USB bus when an Ethernet link is removed and connects to the USB bus when an Ethernet link is provided. Such an embodiment may enable a computer system to implement a power conservation scheme to place a network device and/or a USB host controller into a reduced power state (e.g., a sleep state) when an Ethernet link is not present and the USB to Ethernet device is still physically connected to the USB bus. In other words, the USB device and or the associated components of the USB bus may enter a reduced power state when a network connection is unavailable and the USB device is still physically connected to the USB bus.

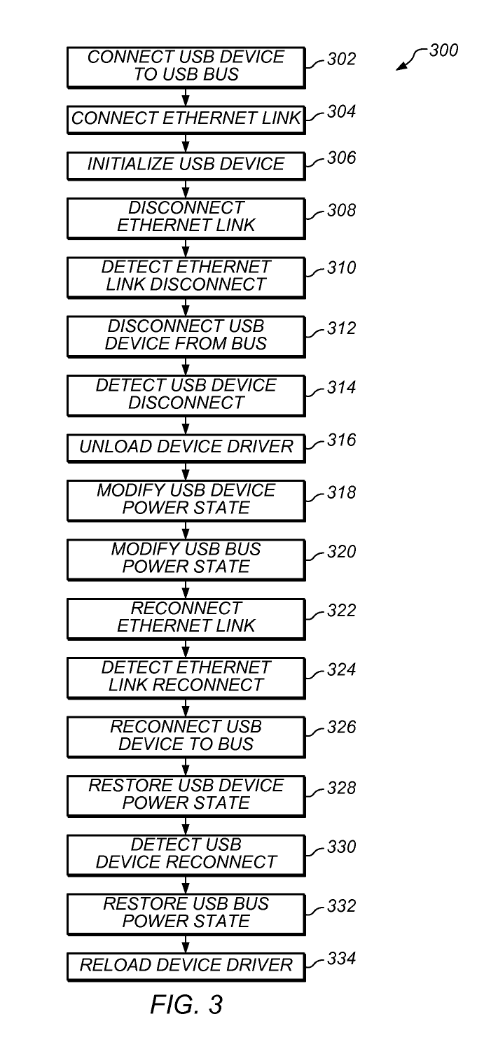

FIG. 3 is a flowchart that depicts a method 300 of implementing a power conservation scheme in accordance with one or more embodiments of the present technique. Method 300 includes connecting a USB device to a USB bus, as depicted at block 302. In one embodiment, a USB device may include a network device, such as a USB to Ethernet device described above with respect to USB device 102. In one embodiment, USB device 102 may be connected to a USB bus via a USB host controller, such as USB host controller 128 described above. For example, the USB device may include USB device 102 as an integral or external component of computer system 100 coupled to USB Host Controller 128. Where USB device 102 is an external component of computer system 100, connecting USB device to the USB bus may include a user physically plugging in a USB connector of the USB device into a USB port of the USB Host Controller or computer system.

Method 300 also includes connecting an Ethernet link, as depicted at block 304. In one embodiment, connecting an Ethernet link includes providing, to the USB device, a connection to a network and/or the internet. In one embodiment, providing a connection includes physically connecting an Ethernet cable or a similar cabling device to an Ethernet port of the USB device. In one embodiment, providing a connection includes simply enabling a network connection to the Ethernet port the USB device is connected to. In other words, a cable may already be connected, and the network connection is simply enabled (e.g., in software) to provide connection of the Ethernet link. In one embodiment, a controller of the USB device includes a status bit that is set to indicate that a connection is present. The status bit may be used to assess and determine whether or not the USB device should be connected to the USB bus. For example, when an Ethernet link is established, the bit may be set to indicate that the USB device should be connected to the USB bus. Similarly, the USB device may include a status bit that is indicative of whether or not the USB device is connected to the USB bus.

Method 300 includes initializing the USB device, as depicted at block 306. In one embodiment, initializing the USB device includes the USB host controller loading device drivers for the USB device. For instance, USB Host controller may detect and recognize the type and/or model of the USB device and load a specific and/or generic device driver to support operation of the USB device on the USB bus.

Method 300 also includes disconnecting the Ethernet link, as depicted at block 308. In one embodiment, disconnecting the Ethernet link includes physically disconnecting a network connection or Ethernet cable from between the USB device and the network. In one embodiment, disconnecting the Ethernet link includes disabling the connection in software. In one embodiment, disconnecting the Ethernet link may simply include the unintentional loss of the Ethernet link, such as when the network/internet is down or otherwise unavailable.

Method 300 includes detecting the Ethernet link disconnect, as depicted at block 310. In one embodiment, detecting the Ethernet link disconnect includes the USB device detecting that the Ethernet link has been removed or is otherwise unavailable (e.g., the Ethernet link is inactive). In one embodiment, detecting may include assessing the state of the Ethernet connection and immediately making a determination that the Ethernet link has been disconnected. In another embodiment, detecting may include assessing the state of the Ethernet connection over a period of time and, only after it has been determined that the Ethernet link has been disconnected for a sufficient amount of time or is otherwise an unreliable connection, determining that the Ethernet link has been disconnected. In one embodiment, a controller of the USB device includes a status bit that is set to indicate that a connection is not present. For example, when an Ethernet link is disconnected, the bit may be set to indicate that the USB device should be disconnected from the USB bus.

Method 300 also includes disconnecting the USB device from the USB bus, as depicted at block 312. In one embodiment, disconnecting the USB device from the USB device includes modifying connections to the USB bus such that the USB host controller may determine that the USB device is disconnected from the USB port and/or the USB host controller, even if the USB device has not been physically removed from the USB bus. In other words, the USB host controller may determine that the USB device is disconnected from the bus (e.g., unplugged form a USB port) even though it is still physically coupled to the USB bus (e.g., plugged into a USB port).

In one embodiment, disconnecting the USB device from the USB bus (block 312) includes an internal feature of a controller (e.g., an application specific integrated controller (ASIC)) of the USB device. For example, software routines may be executed to implement one or more logic routines and/or physical controls to enable the USB device to appear to the USB bus to be disconnected. In one embodiment, an external circuit including USB switching in combination with general purpose inputs and outputs (GPIOs) can be driven or read by a controller (e.g., an ASIC) of the USB/Network device. In one embodiment, disconnection of the USB device from the USB bus includes switching off of certain lines such that the USB bus will make a determination that the USB device has been disconnected from the USB bus. For example, in one embodiment, pull-up and pull-downs are switched off to remove a connection of the USB device to data lines (D+ and D−) of the USB bus. Connections to power lines (VBUS and GND) may remain connected such that the USB/Network device has sufficient power to continue operation. For example, even when appearing to be disconnected, the USB device may have enough power to continue operation in a low power state to assess and detect whether or not the Ethernet link is later reconnected/reestablished. In one embodiment, initialization of the device driver, such as at block 306, may enable one or both of these internal and external features by sending appropriate control transfers over the USB bus to the USB device to enable the internal feature, the external feature and/or manage the associated GPIO's. In one embodiment, a status bit of the USB device is set to indicate that the USB device is no longer connected to the USB bus.

Method 300 also includes detecting disconnect of the USB device, as depicted at block 314. In one embodiment, detecting disconnect of the USB device includes the USB host controller recognizing that the USB device is no longer sufficiently connected to the USB bus. In one embodiment, the USB host controller recognizes the lack of signals on the data lines (D+ and D−) as indicative of the disconnected USB device.

Method 300 includes unloading device drivers, as depicted at block 316. In one embodiment, upon detection that the USB device has been disconnected, the USB host controller may initiate removal of the device drivers associated with the USB device. For example, the USB host controller may unload the drivers loaded during initialization of the USB device at block 306. With the device drivers unloaded, no further activity should remain on the USB port associated with the USB device and/or the unloaded drivers. In one embodiment, a status bit of the USB device is set to indicate that the USB bus has unloaded the device drivers.

Method 300 includes modifying the USB device power state and modifying the USB bus power state, as depicted at blocks 318 and 320, respectively. In one embodiment, modifying the USB device power state includes reducing or otherwise modifying the power state such that the USB device is able to operate in a low power sleep state or similar reduced power state that is capable of at least detecting when the Ethernet link is reconnected or otherwise reestablished with the USB device. For example, the USB device may only be supplied enough power to execute routines to determine that the Ethernet link has been restored.

In one embodiment, modifying the USB bus power state includes placing the USB host controller, the ICH, related processors, and/or other similar components of the computer system, into a reduced power state. The reduced power state may include a sleep or similar power state that is typically reserved for times when no USB peripheral devices are connected to the USB bus. For example, the USB host controller processor may be set to a sleep or deep sleep state. Setting the components to a sleep state may enable the computer system to conserve power that may otherwise be used by the processor to monitor the USB bus even when the Ethernet link was disconnected or otherwise available to the USB device.

Method 300 includes reconnecting the Ethernet link, as depicted at block 322. In one embodiment, reconnecting an Ethernet link includes providing, to the USB device, a connection to a network and/or the internet. In one embodiment, providing a connection includes physically connecting an Ethernet cable or a similar cabling device to an Ethernet port of the USB device. In one embodiment, providing a connection includes simply enabling a network connection to the Ethernet port of the USB device. In other words, the cable may already be connected, and the network connection is simply enabled to provide connection of the Ethernet link.

Method 300 includes detecting the Ethernet link reconnect, as depicted at block 324. In one embodiment, detecting the Ethernet link reconnect includes the USB device detecting that the Ethernet link has been restored or is otherwise available (e.g., the Ethernet link is active). In one embodiment, detecting may include assessing the state of the Ethernet connection and immediately making a determination that the Ethernet link has been disconnected. In another embodiment, detecting may include assessing the state of the Ethernet connection over a period of time and, only after it has been determined that the Ethernet link has been reconnected for a sufficient amount of time or is otherwise a reliable connection, determining that the Ethernet link has been reconnected. As discussed above, detecting whether or not the Ethernet link has been reconnected may be accomplished by the USB device operating in the reduced/modified power state as provided at block 318. In one embodiment, a status bit of the USB device is set to indicate that a connection is present. Further, the status bit or another status bit may be set to indicate that USB device should be connected to the USB bus.

Method 300 includes reconnecting the USB device to the USB bus, as depicted at block 326. In one embodiment, reconnecting the USB device to the USB device includes modifying connections to the USB bus such that the USB host controller may determine that the USB device is reconnected to a USB port of the USB host controller. In one embodiment, reconnecting the USB device to the USB bus may include reversing disconnect operations provided at block 312. For example, in one embodiment, pull-up and pull-downs are switched on to restore a connection of the USB device to data lines (D+ and D−) of the USB bus. In one embodiment, a status bit of the USB device is set to indicate that at least an attempt has been made to reconnect the USB device to the USB bus.

Method 300 includes restoring the USB device power state, as depicted at block 328. In one embodiment, restoring the USB device power state includes modifying the power state back to an operational power state associated with general use and operation of the USB device. In one embodiment, restoring the USB device power state (block 238) may be provided prior to reconnecting the USB device to the USB bus (block 326).

Method 300 includes detecting reconnect of the USB device, as depicted at block 330. In one embodiment, detecting reconnect of the USB device includes the USB host controller recognizing that the USB device is sufficiently connected to the USB bus. In one embodiment, the USB host controller recognizes the presence of signals on the data lines (D+ and D−) as indicative of the reconnected USB device. In one embodiment, a status bit of the USB device is set to indicate that the USB device is reconnected to the USB bus.

Method 300 includes restoring the USB host controller power state, as depicted at block 332. In one embodiment, restoring the USB controller power state includes modifying the power state of USB host controller, the ICH, related processors, and/or other similar components of the computer system back to an operational power state associated with general use and operation of the USB bus and other components of the system.

Method 300 includes reloading the device drivers, as depicted at block 332. In one embodiment, reloading device drivers includes reloading device drivers associated with the USB device reconnected at block 326. In one embodiment, reloading device drivers includes loading one, several or all of the device drivers previously loaded and/or unloaded at blocks 306 and 316. With the driver reloaded and operational power restored, USB device should continue normal operation on USB bus. In one embodiment, a status bit of the USB device is set to indicate that the USB device drivers have been reloaded.

In some embodiments, a method may include detecting an Ethernet link disconnect at the USB device coupled to the USB bus. The method may also include disconnecting the USB device from the USB bus. Disconnecting the USB device from the USB bus may include suspending operations on certain data lines or disconnecting one or more data lines such that the USB bus recognizes the USB device as being disconnected. The method may also include maintaining power to the USB device and modifying a power state of the USB device to a reduced power state that allows the USB device to monitor a status of the Ethernet disconnect. The method may also include automatically reconnecting the USB device to the USB bus when an Ethernet link reconnect is detected.

In some embodiments, a method may include detecting an Ethernet disconnect at a USB device coupled to a USB bus. The method also includes disconnecting the USB device from a USB host controller. Disconnecting the USB device from the USB host controller may include suspending operations on or disconnecting one or more data lines such that the USB host controller recognizes the USB device as being disconnected and maintaining power to the USB device. The method may also include modifying a power state of the USB device to a reduced power state that is that allows monitoring a status of the Ethernet disconnect, unloading device drivers associated with the USB device, and modifying of a power state of one or more components of the USB bus to a reduced power state. The method may also include automatically reconnecting the USB device to the USB bus when an Ethernet link reconnect is detected.

Although the embodiments above have been described in considerable detail, numerous variations and modifications will become apparent to those skilled in the art once the above disclosure is fully appreciated. It is intended that the following claims be interpreted to embrace all such variations and modifications. For example, it will be appreciated that the above described method 300 is illustrative. Other embodiments may include various modifications and alterations that still fall within the scope of the contemplated embodiments. For example, one or more method steps may be rearranged such that the method is employed in a different order than described herein. Further certain steps may be removed repeated or added to the described method 300. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to. As used herein, the singular forms “a”, “an” and “the” include plural referents unless the content clearly indicates otherwise. Thus, for example, reference to “a device” includes a combination of two or more devices.

What is claimed is:

1. A method, comprising:
detecting disconnect of a link at a Universal Serial Bus (USB) device coupled to a USB host via a USB bus;
disconnecting the USB device from the USB bus, wherein disconnecting the USB device from the USB bus comprises configuring the USB device such that the USB host is able to recognize the USB device as being disconnected from the USB bus; and
modifying a power state of the USB device to a reduced power state, wherein the reduced power state is configured to allow the USB device to monitor a status of the link such that the USB device is able to detect a reconnect of the link.

2. The method of claim 1, further comprising, when a reconnect of the link is detected, automatically reconnecting the USB device to the USB bus such that the USB host is able to recognize the USB device as being connected to the USB bus.

3. The method of claim 1, wherein the link comprises an Ethernet link configured to provide access to a computer network.

4. The method of claim 1, wherein the USB host comprises a USB host controller device.

5. The method of claim 1, wherein disconnecting the USB device from the USB bus comprises suspending operations on, or disconnecting a connection of, one or more data lines between the USB device and the USB bus.

6. The method of claim 1, wherein disconnecting the USB device from the USB bus comprises providing a connection of the USB device to a power source such that the USB device is provided sufficient power to enable the USB device to monitor the status of the link in the reduced power state.

7. The method of claim 1, wherein disconnecting the USB device from the USB bus comprises setting a status bit indicative of the connection status of the USB device to the USB bus.

8. The method of claim 1, wherein disconnecting the USB device comprises maintaining a connection of the USB device to the USB host device via the USB bus.

9. The method of claim 1, wherein disconnecting the USB device from the USB bus is configured to enable the USB host to unload device drivers associated with the USB device.

10. The method of claim 1, wherein disconnecting the USB device from the USB bus is configured to enable the USB host to enter a sleep state.

11. A Universal Serial Bus (USB) device, comprising:
a first port configured to couple to a USB bus;
a second port configured to couple to a link; and
a USB device controller configured to:
monitor the status of the link to determine if the link is connected or disconnected; and
wherein, if it is determined that the link is disconnected, the USB device controller is configured to:
disconnect the USB device from the USB bus, wherein disconnecting the USB device from the USB bus comprises configuring the USB device such that a USB host recognizes the USB device as being disconnected from the USB bus; and
modifying a power state of the USB device to a reduced power state, wherein the reduced power state is configured to allow the USB device to monitor a status of the link such that the USB device is able to detect a connection of the link.

12. The device of claim 11, wherein, if a connection of the link is detected, the USB device controller is further configured to reconnect the USB device to the USB bus such that the USB host is able to recognize the USB device as being connected to the USB bus.

13. The device of claim 11, wherein the USB host comprises a USB host controller device.

14. The device of claim 11, wherein disconnecting the USB device from the USB bus comprises suspending operations on or disconnecting a connection of one or more data lines between the USB device and the USB bus.

15. The device of claim 11, wherein disconnecting the USB device from the USB bus comprises providing a connection of the USB device to a power source such that the USB device is provided sufficient power to enable the USB device to monitor the status of the link in the reduced power state.

16. The device of claim 11, wherein disconnecting the USB device from the USB bus comprises setting a status bit indicative of the connection status of the USB device to the USB bus.

17. The device of claim 11, wherein disconnecting the USB device comprises maintaining a connection of the USB device to the USB host device via the USB bus.

18. The device of claim 11, wherein disconnecting the USB device from the USB bus is configured to enable the USB host to unload device drivers associated with the USB device.

19. The device of claim 11, wherein disconnecting the USB device from the USB bus is configured to enable the USB host to enter a sleep state.

20. A method, comprising:
monitoring a status of an Ethernet Link to a universal serial bus (USB) device to determine if the Ethernet Link is active or inactive; and
providing the USB device in a reduced power state if it is determined that the Ethernet Link is inactive, wherein providing the USB device in a reduced power state comprises:
suspending operations on or disconnecting a connection of one or more data lines between the USB device and a USB bus coupled to a USB host such that the USB host recognizes the USB device as being disconnected from the USB bus; and
providing a connection of the USB device to a power line of the USB bus such that the USB device is provided sufficient power to enable the USB device to monitor the status of the Ethernet Link in the reduced power state.
